(19) United States
(12) Patent Application Publication
(10) Pub. No.: US 2003/0072310 A1
(43) Pub. Date: Apr. 17, 2003

(54) System for transmitting sequences of packets between a server and a mobile terminal

(76) Inventor: Jean-Marc Reme, Montigny le Bretonneux (FR)

Correspondence Address: Michael E. Marion, U.S. Philips Corporation, 580 White Plains Road, Tarrytown, NY, 10591, US

(21) Appl. No.: 10/264,903

(22) Filed: Oct. 4, 2002

(30) Foreign Application Priority Data
Oct. 9, 2001 (FR) 0112982

(51) Int. Cl. H04L 12/28

(52) U.S. Cl. 370/394; 370/412

(57) ABSTRACT

The invention relates to a system for transmitting sequences of packets (RTP) from a server (10) to a mobile terminal (30). The terminal has a buffer (BM) for storing the packets received for a time referred to as the buffer traverse time, which has a minimum fixed value (TT).

The server has a retransmission memory (SM) for storing information relating to packets that may be retransmitted. It also has means for erasing from this retransmission memory the information relating to packets for which the sum of the transmission instant, half the to-and-back transmission time and the minimum buffer traverse time is less than the current instant.

The invention relates to a transmission system comprising at least one server for transmitting sequences of data packets and a terminal for receiving data packets, with a transmission time between said server and said terminal which is variable, said server having a retransmission memory for storing information relating to at least some packets with a view to their possible retransmission, in particular information about the transmission instant of said packets, and means of erasing information contained in said retransmission memory, said terminal having a buffer for storing the packets received before supplying them to a data processing device.

The invention also relates to a terminal and server intended to be used in such a transmission system. It also relates to a method of managing a retransmission memory intended to be used by such a server.

The invention also relates to a computer program containing instructions for implementing such a retransmission memory management method, when it is executed by a processor.

Finally, the invention relates to a signal intended to be transmitted from such a terminal to such a server, which conveys information necessary for the implementation of such a retransmission memory management method.

The invention applies in general terms to any packet transmission through an unreliable network. It applies in particular to the transmission of video data via the Internet to mobile radio communication terminals.

Such a transmission system is described in the article “Design and implementation of reliable protocol for video data produced in real time manner” by Teruyuli Hasegawa, Toru Hasegawa and Toshihiko Kato, published in 1998 in “IEEE Proceedings of 5^{th} International Conference on Real Time Computing System and Application”, page 200. This article describes a system of packet transmission through an ATM network, in which the terminal decides on a time limit beyond which a packet is out of date. This time limit is equal to the transmission instant of the packet plus a fixed value. The packets received are stored in a buffer. The terminal detects the loss of one or more packets when there is a hole in the sequence of packets received. When the time limit is reached for the first packet which follows the hole, this means that all the packets in the hole are out of date. The first packet which follows the hole is then transmitted to the top layer for processing. And the terminal sends information to the server so that the server eliminates all the packets in the hole from its retransmission memory.

It is an object of the invention to propose a transmission system in which the server retransmission memory is managed with more precision.

This object is achieved with a transmission system of the type which has just been described, characterized in that the packets are stored in said buffer for a minimum length of time referred to as the minimum traverse time for said buffer, fixed when said terminal is configured and transmitted from said terminal to said server, and in that said erasure means are provided for erasing from said retransmission memory the information relating to a packet when a comparison taking account of said transmission instant information, the current transmission time between said server and said terminal and the minimum traverse time for said buffer, shows that, if it were retransmitted, said packet would not be received in time to be processed by said processing device.

In the aforementioned prior art, use is made of a fixed value representing the packet transmission time on the network in order to decide on the erasure of the packets in the retransmission memory. According to the invention, the current value of the packet transmission time is used. This is particularly important when the value of the packet transmission time varies significantly. This is particularly the case with a transmission via the Internet: this is because, on the Internet, the transmission time varies a great deal according to the time of day and the connection in question.

In addition, in the aforementioned prior art, it is the terminal that takes the decision to erase a packet and transmits that decision to the server. The cost in bandwidth is therefore high. According to the invention, the erasure decision is taken directly by the server.

It should be noted that, according to the invention, it suffices to transmit the minimum buffer traverse time only once from the terminal to the server, at the start of the communication. It should also be noted that calculating the current value of the packet transmission time requires exchanges of information on the network and therefore consumes bandwidth. However, this calculation is in any event necessary for adapting the server transmission rate to the state of the Internet (if the Internet is very heavily loaded, the server transmission rate is reduced). The erasure mechanism according to the invention therefore causes no additional bandwidth consumption.

The invention will be further described with reference to examples of embodiment shown in the drawings to which, however, the invention is not restricted.

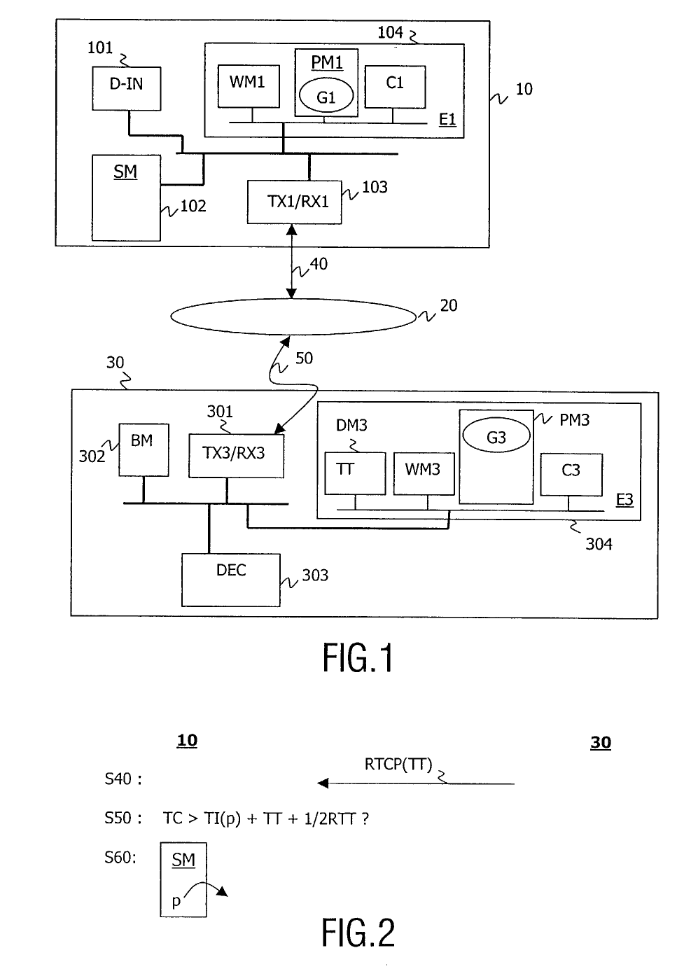

FIG. 1 is a diagram of an example of a transmission system according to the invention,

FIG. 2 is a flow diagram describing the principal steps of a method according to the invention for managing a server retransmission memory.

FIG. 1 shows an example of a transmission system according to the invention comprising a server 10, a transmission network 20, and a terminal 30. The transmission network 20 consists for example of a cellular network, for example a GPRS network or a UMTS network. The server 10 is connected to the transmission network 20 by a link 40, for example a link using a network of the packet type such as the Internet. The terminal 30 is connected to the cellular network by a radio link 50.

The server 10 comprises a data source D-IN represented by a block 101, a retransmission memory SM represented by a block 102, a transmission/reception device TX1/RX1 represented by a block 103, and a microprocessor assembly E1 represented by a block 104. The microprocessor assembly E1 has a working memory WM1, a program memory PM1 and a processor C1. The program memory PM1 contains a program or a set of programs G1 containing program code instructions for implementing a method according to the invention for managing the retransmission memory SM.

The terminal 30 has a transmission/reception device TX3/RX3 represented by a block 301, a buffer BM represented by a block 302, a processing device DEC represented by a block 303, and a microprocessor assembly E3 represented by a block 304. The microprocessor assembly E3 has a working memory WM3, a program memory PM3, a data memory DM3 and a processor C3. The program memory PM3 contains a program G3 containing program code instructions for implementing a method according to the invention for managing the retransmission memory SM.

The data delivered by the data source D-IN are for example video data coded in the MPEG-4 format. In this case, the data source D-IN comprises a video sequence source and a coder of the MPEG-4 type. And the processing device DEC is a decoder of the MPEG-4 type.

Transmission between the server 10 and the terminal 30 advantageously takes place using a transportation protocol of the RTP type. The transportation protocol RTP is described in the document RFC1889 published by the IETF.

The radio link 50 is by nature unreliable. It introduces transmission errors. The retransmission of at least some lost packets, at the request of the receiver, is one way of improving the quality of the data received. For this purpose, the terminal 30 must detect the lost data packets and transmit to the server 10 retransmission requests relating to at least some lost packets.

The useful data are transmitted from the server 10 to the terminal 30 in data packets of the type described in paragraph 5 of RFC 1889. These packets comprise in particular:

a field “Sequence Number”: the sequence number SN contained in this field is incremented by one unit each time a data packet is transmitted. It is intended to be used on reception for detecting the loss of one or more data packets in a sequence of data packets. For example, when the terminal 30 receives a packet whose sequence number is 36, followed by another packet whose sequence number is 40, it deduces therefrom that the packets which contain the sequence numbers 37, 38 and 39 have been lost;

a field “Payload”: the field “Payload” contains the useful data, that is to say, in the example described here, data coded in the MPEG-4 format.

To allow retransmission of a packet, it is necessary to store the fields “Sequence Number” and “Payload” in the retransmission memory SM of the server 10, and the time TI(p) of transmission of the packet (the time TI(p) of transmission of the packet is the time at which the packet p is transmitted for the first time).

The retransmission requests are transmitted from the terminal 30 to the server 10 in check packets of the RTCP type described in paragraph 6 of RFC1889.

A terminal 30 according to the invention receives packets transmitted in sequence by a server 10, stores the packets received in its buffer BM, and extracts the packets stored in the buffer BM in order to supply them to the processing device DEC after a certain buffer traverse time. The buffer traverse time has a minimum value TT stored in the data memory DM3 of the terminal at the time of configuration of the terminal. Imposing a minimum buffer traverse time guarantees that the memory will never be empty when the network is functioning normally, that is to say the processing device DEC will be supplied continuously with packets to be processed. This minimum buffer traverse time is for example around 3 seconds.

FIG. 2 depicts the main steps of a method of managing the server retransmission memory 10. According to FIG. 2, such a method comprises:

a step S40 implemented by the terminal 30 at the start of each new communication with the server 10, which consists, for the terminal 30, of transmitting to the server 10 the minimum value TT of the time taken for traversing its buffer BM;

a step S50 regularly implemented by the server 10, which consists of checking with regard to the packets contained in its retransmission memory SM whether the current instant TC is greater than the sum of half the outward and return transmission time RTT on the network, the minimum buffer traverse time TT and the instant TI(p) of transmission of the packet p in question;

the packets for which TC>TI(p)+½RTT+TT are erased from the retransmission memory SM at step S60.

The outward and return transmission time RTT on the network 20 is calculated regularly by the server 10. For this purpose, the server 10 sends to the terminal 30 a message RTCP of the SR type (from the English Sender Report) as described in paragraph 6.3.1 of RFC 1889, having a sequence number of 1, and whose field “NTP Timestamp” indicates the time of transmission T1 of the message. This message is stored by the server 10. On reception of this message, the terminal 30 notes the arrival time T2 of the message, and returns a message RTCP of the RR type (from the English Receiver Report) whose sequence number is 1, and whose field “DLSR” contains the difference between the time of arrival T2 of the message sent by the server 10 and the time of sending T3 of the response of the terminal 30. The server 10 receives this response at time T4 and calculates the outward and return transmission time over the network as follows: RTT=T4−T1−T3+T2.

The value of the outward and return transmission time on the network being liable to vary greatly over time, it is advantageous to recalculate it very regularly.

On the other hand, as the minimum value of the time taken for traversing the buffer is fixed, it suffices to send it only once from the terminal 30 to the server 10, at the start of the communication. For example, this value is transmitted in the form of an application parameter (“profile specific extension”) in the first response message transmitted by the terminal 30 to the server 10 when outward and return transmission time on the network is first calculated.

1. A transmission system comprising at least one server (10) for transmitting sequences of data packets and a terminal (30) for receiving data packets, with a transmission time (½ RTT) between said server and said terminal which is variable, said server having a retransmission memory (SM) for storing information relating to at least some packets with a view to their possible retransmission, in particular information about the transmission instant of said packets (TI(p)), and means of erasing information contained in said retransmission memory, said terminal having a buffer (BM) for storing the packets received before supplying them to a data processing device (DEC), characterized in that the packets are stored in said buffer for a minimum time referred to as the minimum buffer traverse time (TT) fixed when said terminal is configured and transmitted from said terminal to said server, and in that said erasure means are provided for erasing from said retransmission memory the information relating to a packet when a comparison taking account of said information transmission instant (TI(p)), the current transmission time between said server and said terminal (½ RTT), and the minimum buffer traverse time (TT), shows that, if it were retransmitted, said packet would not be received in time to be processed by said processing device.

2. A terminal (30) intended to receive data packets transmitted in sequence by a server which is provided with a retransmission memory for storing information relating to at least some packets with a view to their possible retransmission and means of erasing information contained in said retransmission memory, said terminal having a buffer (BM) for storing the packets received before supplying them to a data processing device (DEC), characterized in that the packets are stored in said buffer for a minimum time referred to as the minimum buffer traverse time (TT), fixed when said terminal is configured, and transmitted from said terminal to said server, said minimum buffer traverse time being intended to be taken into account by said means of erasing information contained in said retransmission memory.

3. A server (10) intended to transmit sequences of data packets to a terminal (30), with a transmission time (½ RTT) between said server and said terminal which is variable, said server having a retransmission memory (SM) for storing information relating to at least some packets with a view to their possible retransmission, in particular information about the transmission instant of said packets (TI(p)), and means of erasing information contained in said retransmission memory, characterized in that, said terminal having a buffer (BM) for storing the received packets for a minimum length of time referred to as the minimum buffer traverse time (TT) before supplying them to a data processing device (DEC), said minimum buffer traverse time being fixed when the terminal is configured and transmitted from said terminal to said server, said erasure means are provided for erasing from said retransmission memory the information relating to a packet when a comparison that takes account of said information about the transmission instant (TI(p)), the current transmission time between said server and said terminal (½ RTT), and the minimum time taken for traversing said buffer (TT), shows that, if it were retransmitted, said packet would not be received in time to be processed by said processing device.

4. A method of managing a retransmission memory (SM) of a server (10) intended to transmit sequences of data packets to a terminal (30) with a transmission time (½ RTT) between said server and said terminal which is variable, said retransmission memory being provided for storing information relating to at least some packets with a view to their possible retransmission, in particular information about the transmission instant of said packets (TI(p)), said method including a step of erasing information contained in said retransmission memory, characterized in that, said terminal having a buffer (BM) for storing the received packets for a minimum length of time referred to as the minimum buffer traverse time (TT) before supplying them to a data processing device (DEC), said minimum buffer traverse time being fixed when said terminal is configured and transmitted to said server, said erasure step consists of erasing from said retransmission memory the information relating to a packet when a comparison that takes account of said information about the transmission instant (TI(p)), the current transmission time between said server and said terminal (½ RTT), and the minimum time taken for traversing said buffer (TT), shows that, if it were retransmitted, said packet would not be received in time to be processed by said processing device.

5. A program containing instructions for implementing a method as claimed in claim 4 for managing a retransmission memory, when it is executed by a processor.

6. A signal (RTCP(TT)) intended to be transmitted from a terminal as claimed in claim 2 to a server as claimed in claim 3, characterized in that it conveys the value of the minimum time taken for traversing the buffer of said memory.
